(19) United States
(12) Patent Application Publication
(10) Pub. No.: US 2023/0306436 A1
(43) Pub. Date: Sep. 28, 2023

(54) NETWORK COMPUTING SYSTEM TO IMPLEMENT CONTENT MANAGEMENT PLATFORM FOR NETWORK SERVICES

(71) Applicant: Uber Technologies, Inc., San Francisco, CA (US)

(72) Inventors: Anuj Chauhan, Bangalore (IN); Aravind Ranganathan, Bangalore (IN); Ajish Abraham, Bangalore (IN)

(21) Appl. No.: 17/866,293

(22) Filed: Jul. 15, 2022

(30) Foreign Application Priority Data
Mar. 23, 2022 (IN) 202241016058

(51) Int. Cl. G06Q 30/00; G06Q 10/06

(52) U.S. Cl. CPC G06Q 30/016; G06Q 10/0639

(57) ABSTRACT

A network computing system that implements a content management platform for a network service. In examples, the network computing system operates to determine an effectiveness of individual content items based at least in part on actions which users take after consuming the content items.

### RELATED APPLICATION(S)

This application claims benefit of priority to Provisional Indian Patent Application No. 202241016058, filed Mar. 23, 2022; the aforementioned priority application being incorporated by reference in its entirety for all purposes.

### TECHNICAL FIELD

Examples described herein relate to a network computing system to implement a content management platform for use with network services.

### BACKGROUND

Business enterprises use customer support platforms to manage customer relations. Customer support platforms are often developed with specific needs and resources of the business that is supported, and over time, the needs of the customer support platform may also change. For example, businesses that utilized live agents and phones in short time have had to develop social network channels to handle customer support on different types of social networks. As another example, on-demand services may with growth, experience a need to resolve customer issues in real-time, as they occur, in which case the business may need to develop a messaging channel where support content is delivered through reply messages.

Increasingly, customer support platforms have become technology intensive computing platforms that handle a large volume of customer inquiries. The specific number of inquiries which a customer support platform may receive can vary based on the number of customers. For many business, there are not enough live agents to handle such inquiries in a reasonable time frame. As a result, customer support platforms typically utilize automation (e.g., bots), artificial intelligence (e.g., to decipher a topic of the inquiry), data structures and indexes for searching or matching inquiries to issues or persons, data models, load balancing and numerous other technologies.

### BRIEF DESCRIPTION OF THE DRAWINGS

FIG. 1 illustrates a network computing system for implementing a content management platform, according to one or more examples.

FIG. 2 illustrates an example method for a network computing system to determine effectiveness of content items of a content repository.

FIG. 3 illustrates an example method for a network computing system to send reply communications that integrate content items based on effectiveness.

FIG. 4 illustrates a computer system on which one or more embodiments can be implemented.

### DETAILED DESCRIPTION

Embodiments provide for a network computing system that implements a content management platform for a network service. In examples, the network computing system operates to determine an effectiveness of individual content items based at least in part on actions which users take after consuming the content items.

In some examples, the network computing system operates to generate reply communications to user inquiries, where the reply communications integrate content items that are responsive to or relevant to the respective inquiries. The network computing system can determine the effectiveness of the content items based on actions which the corresponding users take via inputs that are provided on their respective client or computing devices after receiving the reply communication.

According to some examples, the effectiveness of individual content items can affect future use of the content item, as well as whether alternative versions of the content item are deployed.

Embodiments as described recognize that as businesses grow and expand, the ability to scale customer support content and resources has become more challenging. For example, customer support content developed for live agents may not transfer to a channel that utilizes message responses, as the live-agent content may have been developed for scripts that can be used by a live agent, while message responses are automatically generated based on the content provided by the user.

Embodiments further recognize that content management platforms, such as those that support content for customers, can often be disjointed, such as in the case where enterprise support different businesses that originated at different times or from different sources. In such cases, existing content management platforms may utilize different customer support resources for their business, with each business having configured their respective customer support resources for use with specific channels, data models and computing resources. In such situations, the content management platforms can be inefficient and duplicative in effort and resources.

Embodiments provide for a network computing system to implement a content management platform that addresses numerous technological challenges present with existing content management platforms. In particular, embodiments provide for a network computer system to implement a content management platforms that is robust and scalable to support different user engagement channels. Further, the network computing system can determine the effectiveness of the content items that are deployed with the content management platform, such that more effective content items are deployed to promote desired responses from users that consume the content items.

As used herein, a client device refers to devices corresponding to desktop computers, cellular devices or smartphones, wearable devices, laptop computers, tablet devices, television (IP Television), etc., that can provide network connectivity and processing resources for communicating with the system over a network.

One or more embodiments described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more embodiments described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some embodiments described herein can generally require the use of computing devices, including processing and memory resources. For example, one or more embodiments described herein may be implemented, in whole or in part, on computing devices such as servers, desktop computers, cellular or smartphones, tablets, wearable electronic devices, laptop computers, printers, digital picture frames, network equipment (e.g., routers) and tablet devices. Memory, processing, and network resources may all be used in connection with the establishment, use, or performance of any embodiment described herein (including with the performance of any method or with the implementation of any system).

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, embodiments may be implemented in the form of computer-programs, or a computer usable carrier medium capable of carrying such a program.

### System Description

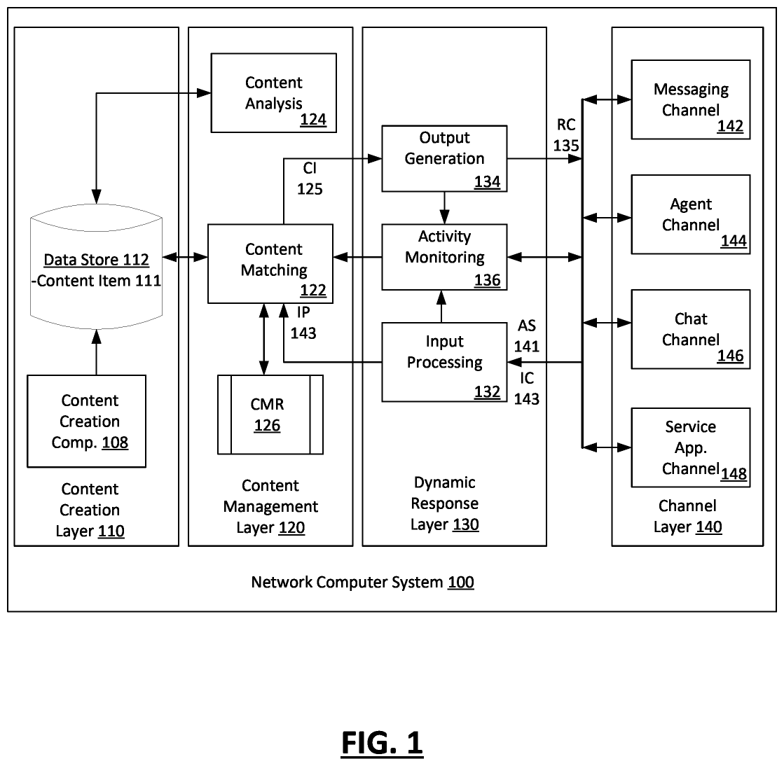

FIG. 1 illustrates a network computing system for implementing a content management platform, according to one or more examples. With respect to examples as described, the network computing system 100 can be implemented on a server, on a combination of servers, and/or on a distributed set of computing devices which communicate over a network such as the Internet. Still further, some examples provide for the network computing system 100 to be distributed using one or more servers and/or mobile devices. In some variations, the network computing system 100 is implemented as part of, or in connection with a network system, where, for example, operators use service vehicles to provide transport-related services between locations. In variations, the network computing system 100 may be implemented using mobile devices of users, including transport providers and consumers, with the individual devices executing a corresponding service application that causes the computing device to operate as an information inlet and/or outlet for the network computing system 100.

In some examples, the network computing system 100 implements a content management platform for use with network services (e.g., on demand services) that engage users utilizing web services, social networks and/or mobile devices (e.g., using service applications running on user devices). The network services can include on-demand services, such as on-demand services to provide transport, food delivery, grocery delivery, shipping and the like. In context of on-demand services, users can include service providers (e.g., users who provide transport services for others) and requesters (e.g., users who request services through a network service).

According to examples, the network computer system 100 includes a content creation layer 110, a content management layer 120, a dynamic response layer, and a channel layer 140. As described in more detail, the content creation layer 110 includes processes for creating and storing content items with a data store 112. In examples, content creation layer 110 can enable content generation through authoring, programmatic generation, content retrieval (e.g., crawling content repositories), and versioning. The content management layer 120 includes processes to match content items to input communications received from users through the channel layer 140. The dynamic response layer 130 includes processes that manage interactions with end users through the channel layer 140.

The channel layer 140 includes processes that interface and engage with a customer using a particular communication medium, where each communication medium is characterized by a communication protocol and/or interface under which engagement with the user may occur. The engagement with the user can include indirect engagement, such as activity signals (e.g., user searching for an issue on a website or user viewing a support article or FAQ) from which a user issue and/or sentiment can be detected. In examples, the engagement with the user can also include direct communications with the user, such as communications (e.g., emails, in-app messages, social network message, chats, voice or telephony calls, etc.) received from the user, and communications sent to the user (e.g., emails, in-app messages, social network message, chats, agent voice communications).

In an example shown, the channel layer 140 includes a messaging channel 142, agent channel 144, chat channel 146 and service application channel 148. The messaging channel 142 can be implemented by one or more processes that receive and/or send messages to the user using, for example, a third-party service (e.g., email service, social network service, etc.). The agent channel 144 includes processes which exchange content and communications with a live agent (e.g., person speaking with an end user). The chat channel 146 include processes that interface with real-time messaging components where users can communicate in real-time with human or artificial agents. The service application channel 148 can include processes that communicate with service applications that operate on end user devices. Users may download service applications on to their mobile devices. Once download, the service applications can access hardware and software resources of the user's mobile device, to enable access to functionality such as location-determination (e.g., via GPS), touch screens, accelerometers, gyroscopes and other sensors. In examples, service applications can be dedicated to communicating with a particular source, in connection with enabling users to receive network services, such as on-demand services for transport, food delivery, grocery delivery, shipping and the like. The service application can provide users with an issue resolution interface where problems and complaints raised by the user can be received and handled by a network service. The issue resolution interface can enable, for example, users to send and receive in-app messages (e.g., asynchronous messages, chats, etc.), as well as view a knowledge library.

In examples, the service application channel 148 can include multiple sub-channels. For example, the service application channel 148 can be implemented by a distributed process on the network computer system 100 that communicates with a corresponding service application operating on an end user device. Through such communications, the service applications can execute on corresponding user devices to provide in-app messaging, chat services, issue resolution service and/or a knowledge library.

As an addition or variation, different network services may be provided through one or more channels of the channel layer 140. For example, the service application channel 148 can provide multiple types of on-demand services, such as on-demand services for human transport, food delivery, grocery delivery, or shipping. Alternatively, different network services may be provided through different service applications on a user computing device.

### Content Creation Layer

The content creation layer 110 can include one or more content creation components 108, and content data store 112 to store a collection of content items 111. The content creation components 108 can include processes to enable an author interface, including human or programmatic (“AI”) authors. The content creation components 108 can also include content aggregation processes, including content to process, evaluate and/or edit content items. Content creation component 108 can further include processes that version existing content items.

In some examples, content creation layer 110 includes logic that structures content items into “blocks”, where each block is associated with a set of metadata. In some variations, blocks represent the smallest segment of content that has an individually associated set of metadata. For example, in the case of a saved messaging reply, a separate block can be provided for each of a header, body and footer. In other variations, types of content items include text files, media files (or documents with embedded media components), blog postings or journal articles. When structured as blocks, content items can be dynamically assembled at time of use into a cohesive, human-understandable output.

In examples, the content items 111 are stored in the content data store 112 in a neutral format, such that the content item can be utilized with any of the channels supported in the channel layer 140. When stored in the neutral format, the content items can be reused amongst different channels. Each content item 111 of the collection can also be associated with a set of metadata. The set of metadata can include, for example, a content identifier, a version identifier, a create or modifier date, an author identifier, and/or tags, where individual tags identify characteristics of the content item. The characteristics of the content item can identify relevant topics and/or sub-topics of the content item, key words, one or more context, and/or one or more semantic parameters. Each content item 111 can also be categorized based on the characteristics and/or other metadata associated with the content item. For example, a category schema can be defined for content items, based on their respective tags, with categories being defined for combinations and sub-combinations of characteristics. Accordingly, the metadata or tags of the content items 111 can also identify determined categories of the respective content item.

The context characteristics can identify or correspond to a channel type, such as a messaging channel 142, agent channel 144, chat channel 146 and service application channel 148. As an addition or variation, the context can identify a type of service for which the content item pertains to (e.g., on-demand transport versus food or grocery delivery, etc.). Additionally, the context can correspond to characteristics of timing (e.g., time of day, day of week, month, year), geographic location, environmental conditions (e.g., weather), attributes of the network service (e.g., promotional use, regular use) or user of the network service (e.g., repeat user, first time user). The context can also indicate whether the content item is an issue (e.g., user having a problem) or other type of communication, whether the issue is urgent or important, and other characteristics which may be specific to, for example, an issue resolution platform.

The topic/sub-topics can be based on a subject which is deemed relevant to the content item or the context of the content item. The topic/sub-topic can identify, for example, a topic of an issue for resolution. The set of key words include alphanumeric terms which are typically associated with the content item or its relevant topics. The context can include pre-defined context, including context that is specific to a particular channel, as well as context that specifically relevant to a particular network service.

Still further, in other examples, the characteristics of the metadata can reflect a sentiment associated with the content item. For example, the content item can be associated with a positive sentiment, neutral sentiment, or negative sentiment. In additional examples, the sentiment can reflect empathy, such as whether the content item conveys empathy, or a degree to which the reply message conveys empathy (e.g., very empathetic, moderately empathetic, not empathetic).

Additionally, individual content items 111 can be associated with one or more performance metrics which indicate the effectiveness of the content item. The performance metric can correspond to, for example, a score that represents an effectiveness of the content item in causing a desired response with a user that consumes the content item. In this regard, the effectiveness can be structured as one or more scores that reflect a likelihood that the user will respond (or not respond) in a particular manner, such as by having a positive or negative reaction in sentiment or by performing a desired or undesired action. As described with examples, the effectiveness (or performance metric) can be based on direct feedback from the consuming user, such as quantitative input the user provides (e.g., rating) regarding (i) the quality (or usefulness) of a content item and/or input the user provides regarding a content item, and/or (ii) a product or service which the consumed content item relates to.

In variations, the effectiveness can also be determined indirectly through actions which the user performs or does not perform. In particular, the effectiveness of a content item can be correlated to action(s) a user may take subsequent to consuming a content item, where the action is indicative of the usefulness of the content item and/or the sentiment of the user about the content item and/or product or service which the consumed content item relates to.

In examples, the performance metric of individual content items can be made specific to a category of the content item. The category can be selected from a predefined category schema, based on, for example, pre-selected combinations of characteristics and other metadata associated with the content item. For example, a category of a content item can specify the content type as being a message reply, the context as being an issue resolution that is urgent, and a sentiment that is neutral and empathetic, where the performance metric of the content item reflects a likelihood that the user will respond to the reply message positively (e.g., with a message that includes a positive reply like “thank you”, or subsequent feedback that provides a good rating as to how the issue was resolved).

In examples, the metadata set associated with each content item can also identify one or more types of responses from the user which can directly or indirectly reflect an effectiveness of the content item. For example, for a given content item, the type of indicative user actions can include direct user feedback (e.g., user responds to a question following consumption of the content item with direct feedback, such as “the issue was resolved,” “thank you” or a rating score).

### Input Processing

The input processing component 132 of the dynamic response layer 130 includes processes that communicate with the components of the channel layer 140 to detect input signals of users. The input signals can include activity signals 141 and/or communications 143 of users (transmitted via user devices). The activity signals 141 can correspond to user-activity other than a direct communication. For example, activity signals 141 can reflect search, navigation and viewing of articles (e.g., FAQ) and other content in a support knowledge base. Accordingly, the input processing component 132 detects and processes activity signals 141 received through, for example, the service application channel 148 or through a web-channel, by detecting information about a user performing an activity related to a content item supplied through the data store 112. The input processing component 132 records metadata associated with the activity signals 141

In examples shown by FIG. 1, the input processing component 132 can also process incoming communication 143 received through the channel layer 140. For example, incoming communications 143 may be received through a service application channel 148, such as in the case where a mobile device user operates a service application to communicate an in-app message regarding an issue that the user is having with respect to an on-demand service (e.g., transport service, food a grocery delivery, etc.). In other examples, the incoming communication 143 can be received through the chat channel 146. In such implementations, the incoming communication 143 can include, for example, an online form that the user completes. Alternatively, the chat channel 146 can be implemented through a website that includes a chatbot which fields inquiries from users. In other variations, the incoming communication 143 can be provided to the agent channel 144. For example, a help center can field a voice call or live message inquiry where the user communicates in real-time with a person, and the contents of the inquiry can be received as text input by the input processing component 132. Still further, in other examples, the incoming communication 143 can be received through the messaging channel 142.

According to examples, input processing component 132 (i) records metadata associated with the activity signal 141 and/or communication 143, where the metadata enables user activity to be identified and/or enable reply communications to be sent to the user; and (ii) determines input parameters 131 based on contents and metadata of input communications 143. As described, the recorded metadata can be used to monitor subsequent user activity and/or to address reply communications 135 to the user. Additionally, the input processing component 132 can process communications 143 to determine input parameters 131 that can be matched to content items stored with the data store 112.

In examples, the metadata recorded by the input processing component 132 can include (i) one or more user identifiers (e.g., first name, last name, account identifier, device identifier, messaging identifier, etc.); (ii) the communication channel of the input signal or communication; (iii) topical designations specified by user input for the activity of the activity signal 141 or the incoming communication 143 (e.g., help inquiry); (iv) session, thread or agent identifier (e.g., based on the channel component being used); and/or (v) one or more types of contextual information (e.g., content type, type of network service provided to the user, etc.).

In the case where the activity signal 141 reflects an activity of the user, the identified metadata can also include information about the activity, including information that identifies content items 111 of data store 112 which the user may be viewing (e.g., FAQ, help article, support menu in knowledge base, etc.).

In examples, the recorded metadata can also include contextual transaction information pertaining to a user activity of the input communication 143. In on-demand services, the contextual metadata can include information about the user's service request or service-related activity. For example, the user can operate the service application for an on-demand service to send an inquiry about a particular service request of the user, in which case the contextual metadata can include, for example, time stamps when service requests are made, received or completed, the amount charged to the user, the type of service requested, a rating the user provided for the service, and/or other information.

The input parameters 131 associated with an incoming communication 143 can include or be based on the metadata of the incoming communication 143. Additionally, the input processing component 132 can implement logic to determine some input parameters 131, based on, for example, contextual information, keywords, and content analysis of the input communication 143. The input parameters can be defined to correlate to categorical designations and characteristics that are defined for content items 111.

In examples, the input processing component 132 includes logic to parse incoming communications 143 for characteristics, such as keywords and keyword metrics (e.g., metrics that reflect weighting of key keywords). The input processing component 132 can also determine other characteristics of the incoming communication 143, such as topics or subtopics which the communication may relate to (e.g., using keyword analysis).

Additionally, in some examples, the input processing component 132 implements logic to determine a sentiment of the incoming communication 143. For example, the input processing component 132 can determine whether the sentiment of the incoming communication 143 is positive, negative, or neutral. The input parameters 131 can also include select metadata associated with the input communication 143, including contextual metadata.

As an addition or variation, the input processing component 132 can also identify and record the specific communication channel, session identifier and/or user identifier of the incoming communication 143. The recorded information can be associated with the input inquiry 115 such that the reply message transmitted to the user of the incoming communication 143.

As described in greater detail, in some examples, the input processing component 132 detects activity signals 141, reflecting a user viewing a content item. The recorded metadata can identify the user and/or content item that is the subject of the activity. The activity monitoring component 136 can use the recorded metadata to detect one or more activities that the user performs subsequent to viewing the content item 111. Based on the information recorded about the user's subsequent activity, the performance metric of the matched content item(s) 111 in the reply communication are updated.

Additionally, in some examples, the input processing component 132 communicates input parameters 131 for an incoming communication 143 to the content matching component 122. The content matching component 122 implements processes to select content items from a collection, maintained with data store 112. The selection can be implemented by matching input parameters 131 to content items, based on criteria that includes relevancy and effectiveness. Output generation component 134 of the dynamic response layer 130 uses recorded metadata to generate a reply communication 135 for the end user, where the reply communication includes portions or otherwise integrates matched content items. Further, the activity monitoring component 136 uses the recorded metadata to detect information about user activity subsequent to receiving the reply communication 135. Based on the information recorded about the user's subsequent activity, the performance metric of the matched content item(s) 111 in the reply communication are updated.

### Content Management Layer

The content management layer 120 includes processes, represented by content matching component 122, to perform matching and retrieval operations for content items of data store 112. The content management layer 120 also include processes, represented by content analysis component 124, to update the content items 111 of the data store for various metrics, including metrics that are indicative of relevancy and effectiveness (e.g., performance metric).

In examples, content matching component 122 matches input parameters 131 determined from communications 143 of users, to content items 111 stored with the data store 112. In examples, the content matching component 122 maintains content management repository 126, which can include indexes and/or graph or tree structure representations of the collection of content items 111. In some implementations, the content management repository 126 maintains a graph/tree structure having a hierarchical node representation, where each node represents a category or combination of categories of content items. The categorical designations of content items can be sufficiently granular to enable leaf nodes of the graph/tree structure to map to a small number of content items. The content matching component 122 can perform matching operations by processing input parameters 131 determined from the user's communication 143 through the graph/tree structure representation of content management repository 126.

In examples, matched content items satisfy criteria of relevance to the input parameters 131 and effectiveness. Thus, the matching process implemented by the content matching component 122 can identify the most relevant content item for the input parameters 131 (and therefore the user's input communication 143) by navigating the hierarchical data structure representation of the collection of content items 111. The effectiveness of individual content items can be represented by a performance metric that is associated with each content item. The matching process can identify, for example, matched content items to be those that are the most relevant and most effective (based on the determined performance metric). In variations, the matching process can identify matched content items to be those that satisfy threshold levels for relevancy and/or effectiveness.

In some examples, matched content items can be assembled from multiple content items so as to form a cohesive, human-interpretable reply message that is relevant to the input communication 143 of the user. For example, the matching process can identify, based on relevancy, a first content item (e.g., a sentence, phrase or message template) that includes content to address an issue identified by the input parameters 131. Additionally, the matching process can identify a second content item based on effectiveness, where the second content item includes one or more phrases or words that are likely to make the content of the reply message more effective.

In variations, a content item can be versioned to reflect variations that are more effective for different scenarios. A content item that is relevant for a particular issue can include versions that use alternative wording for different sets of input parameters 131. For example, a given content can include alternative variations that convey different levels or kinds of sentiment (e.g., very empathetic, mildly empathetic, or neutral). The particular version that is selected by the content matching component 122 can be based on the effectiveness of each version. Further, the effectiveness of each version of the matched content item can vary for different input parameters 131, meaning the version of the content item that is selected may vary based on the input parameters 131 of the input communication 143. For example, the input parameters 131 can identify a particular channel from which the input communication 143 originates. The content matching component 122 can select the version of the content item 125 that is deemed to be most effective for the particular channel where the user engagement is occurring. Similarly, if the input parameters 131 identify a particular service (e.g., on-demand transport, food delivery, etc.), the matching content item may correspond to the version that is deemed to be the most effective for the particular service. Likewise, if the input parameters 131 of the input communication 143 include a particular sentiment (e.g., negative), then the version of the content item that is selected may be the one that is most empathetic.

As described with examples, the effectiveness of the content items can be reflected by a performance metric associated with each content item (and variations thereof). The performance metric can be determined from historical information, including how other users have responded to the particular content item in the same or similar context. In this way, the determination of effectiveness, as represented by the performance metric of individual content items, can be specific to input parameters 131 and combinations thereof. As a result, the content matching component 122 can identify matched content items for input communications 143, with the particular matched content item being specifically selected or configured to account for sentiment, channel, service-type and/or other contextual input parameters.

### Output Generation

The output generation component 134 represents processes of the dynamic response layer 130 for generating reply communications 135 to input communications 143 of users. The output generation component 134 can generate reply communications 135 based on the one or more matched content items 125 identified by the content matching component 122, and recorded metadata for the incoming communication 143. The matched content items 125 can include, for example, a snippet, sentence or phrase, a composed reply, a template, a link, a document, or other content item. The output generation component 134 includes composition logic that composes the reply communication 135 using the matched content item(s) 125. Further, the output generation component 134 can format or otherwise structure the reply communication 135 for the particular output channel and/or content type of the corresponding input communication 143.

In some examples, reply communications 135 are programmatically composed. For example, the reply communication 135 can be automatically composed for an agent or administrator who can then review and send the reply communication 135. Still further, in some examples, the administrator can edit the suggested reply before sending the reply communication 135. In such examples, the content of the reply communication 135 can be saved with the data store 112. For example, the content of the modified reply communication 135 can be saved as a new version of the content item that was originally suggested. As described in more detail, the performance metric of the new version can be determined through subsequent user actions. An administrator who authored the modification can then see how the modification to the content item performed.

As an addition or variation, the reply communication 135 can be automatically generated and sent to users, responsive to incoming messages 143 being received from those users. Thus, in such examples, the reply communications 135 can be communicated to users automatically, responsive to corresponding incoming communications 143, and without human intervention.

In examples, the output generation component 134 integrates one or more snippets, phrases or other wording with a template for a reply message, where the snippets and template are matched based on their respective relevancy and determined effectiveness to the categories and characteristics of the input communication 143. To illustrate by examples, in the case where the input communication 143 reflects a frustrating event to the end user, the matched content items can combine (i) a snippet of empathy for the frustration the user is experiencing, (ii) a snippet to address a resolution (if one exists) to the issue indicated by the input communication 143, and (iii) a template to structure the snippets. Alternatively, the snippet of empathy can replace or supplement the content of the template.

The output generation component 134 can use metadata of the incoming communication 143 to address or target delivery of the reply communication 135. In one implementation, the reply communication 135 is addressed to an identifier associated with the user, such as a user device identifier (e.g., mobile phone number) or user account identifier. Alternatively, the reply communication 135 can be targeted to a session (e.g., as identified by a session identifier) of a user engagement through one of the components of the channel layer 140. For example, the reply communication 135 can be targeted for a particular chat thread on a website, using a chat or session identifier.

The output generation component 134 can also use the metadata of the incoming communication 143 in the body of the outgoing message. For example, the metadata determined from the input signal can include one or more identifiers for the user (e.g., first name, last name, account identifier, device identifier, messaging identifier, etc.). In this way, the output generation component 134 can integrate one or more relevant identifiers (e.g., first name) in a body of a reply message.

Still further, output generation component 134 can integrate contextual metadata recorded with the incoming communication 143 with the reply communication 135. For example, output generation component 134 can integrate transactional metadata with the reply communication 135, based on, for example, a topical designation of the user's input communication 143. To illustrate, in a scenario where an input communication 143 is from a transport service requester who has designated the subject of his inquiry to be a complaint about the price of the service he received, output generation component 134 can integrate transactional metadata that includes the fare the user was charged. In this way, the output generation component 134 can compose a reply message that integrates the matched content item 125 (e.g., message template) with transaction and user-specific information (e.g., amount the user was overcharged). The reply message 135 can also include content items that express empathy, such that when combined with the transactional information, the resulting reply message 135 is effective in maintaining user engagement and/or loyalty.

To further illustrate, the reply communication 135 can include a message that is addressed to the user (e.g., by first name), and incorporates a message reply template that is selected for relevancy and effectiveness (e.g., to match the negative sentiment of the requesting user). Further, the reply communication 135 can be formatted or otherwise configured for the particular channel of the user's engagement. Thus, for example, a reply communication 135 that is to be communicated to the user via an online chat channel 146 may be made shorter or more informal as compared to a similar reply communication 135 that is communicated across a messaging channel 142. In this way, the reply communication 135 is made to be highly specific to the incoming communication 143.

### User Activity Monitoring

The activity monitoring component 136 represents processes of the dynamic response layer 130 that monitor or otherwise detect user activity in response to content items which the user consumes. In some examples, the user activity can include input activity where the user provides direct feedback that is responsive to their consumption of a particular content item. For example, a user can be prompted by message or otherwise to provide feedback (e.g., provide a rating, a survey, etc.) that is correlative to the effectiveness of a reply communication.

The requested feedback can be tailored to determine whether an issue raised by the user was addressed. The feedback can then be used to determine the relevancy of the reply message to the user's input communication 143, as well as the effectiveness of the reply message (e.g., the completeness and accuracy of the information contained in the reply message). The effectiveness of the content items can be based on determinations of the quality of the content item (e.g., how well the content item addressed an issue raised by the user). Additionally, the determination of effectiveness can be based on the user's sentiment about the content item, and/or the product or service which the consumed content item relates to.

Accordingly, the feedback can request input from the user regarding the quality of the content item and/or their sentiment about the product or service which the content items relate to. Thus, for example, the feedback provided by the user can indicate whether or not, and/or the degree to which the content item resolved an issue raised by the user's input communication 143. Still further, the feedback from the user can indicate whether the content items consumed by the user completely or correctly addressed the issue raised by the user. Additionally, the requested feedback can be tailored to determine the user's sentiment following the user consuming the matched content items. In such examples, the feedback can reflect a propensity of the user to purchase the service again, or to recommend the product or service to another, based on an assumption that the more likely the user is to use the service again, then the more effective the content item was. Still further, the requested feedback can seek to identify whether the user was “satisfied” or “dissatisfied” with the content item which the user consumed.

The activity monitoring component 136 can detect and link user-provided feedback to the matched content items 125 of the reply communication 135. The activity monitoring component 136 can use metadata associated with the reply communication 135 to identify the corresponding matched content items. In implementation, the activity monitoring component 136 can update the data store 112 to associate the direct feedback received for a reply communication 143 to the matched content items of the reply communication. In examples, the activity monitoring component 136 can also associate the context of the reply communication 135 which generated the feedback (e.g., channel used, type of service related to the input communication 143, sentiment of the input communication 143; etc.) and other relevant information with the corresponding content items. In this way, the content items can be associated with feedback that indicates their effectiveness, and/or their effectiveness given a particular context.

Additionally, in examples, the activity monitoring component 136 can monitor a user that consumes a matched content item for activity (or inactivity) that is indicative of the effectiveness of the content item. The effectiveness attributed to the user activity can be positive, neutral or negative. For example, in the case of a network service that is the subject of the input communication 143, the activity monitoring component 136 can monitor for activity that reflects the user remaining engaged with the network service once the reply communication 135 is received by the user. For example, the user's input communication 143 may be received over the service application channel 148, in connection with the user operating a service application to request a particular type of on-demand service (e.g., transport service, food delivery, etc.). The reply communication 135 can be communicated to the user over the service application channel 148. The activity monitoring component 136 can subsequently monitor the activities of the service application to determine information such as (i) the duration of time before the user closed the service application, and/or (ii) whether the user performed additional activities through the service application, such as make another service request or provide a rating or feedback for another user. In such examples, the duration in which the service application remains open can be correlated to a positive, neutral, or negative outcome. For example, if the user immediately closes the service application after viewing the content item, the inference may be that the consumed content items were not effective. However, longer durations may reflect that the consumed content items were neutral or more effective. Still further, if the user makes another service request after viewing the reply message, the inference may be that the content items of the reply message were effective. Likewise, if the user's activity was to leave a review, then the inference made about the effectiveness of the reply communication 135 may be based on the rating the user provides.

In other examples, the activity monitoring component 136 can monitor for subsequent communication(s) from the user through the relevant channel layer 140. For example, if the user is participating in an online chat with a live or artificial agent, the activity monitoring component 136 can determine (i) whether the user continues to have inquiries after consuming the matched content items, and (ii) the sentiment (e.g., positive, negative, or neutral) the user expresses through his subsequent communications. The duration of the communications which occur after the user consumes the content items, as well as sentiment reflected in the communications, can form the basis for determining the performance metric of the consumed content items.

The activity monitoring component 136 can also detect activity signals 141 of users, where the activity signals 141 are indicative of the users consuming content items 111 from the data store 112, separate from instances when users send an inquiry or other input communication. For example, the user activity signal 141 can correspond to the user interacting with a website to view FAQs, browse support topics and read knowledge articles. In response to detection of activity signals 141 relating to a specific content item, the activity monitoring component 136 can monitor for additional user activity that is indicative of the effectiveness of the content item. For example, individual content items from the data store 112 can be published and made accessible to users via web browsers or mobile devices. The activity monitoring component 136 can monitor for the user's response activity after the content item 111 is viewed. For example, the activity monitoring component 136 can view for activities that are indicative of the extent of the user's engagement with the content item 111. The extent of the user engagement can include measuring a length of time which the user took to view the content item. Additional activities that can be monitored includes the user searching for additional content items, the user terminating a session (e.g., user closes the browser or service application) or the user performing an action that is associated with the article (e.g., the user performs steps suggested in the article to resolve an issue). Each of the user's activities can reflect positively, negatively or neutral as to the effectiveness or performance metric.

Still further, in additional examples, the activity monitoring component 136 can monitor to determine whether a user reads the content item 111 by, for example, determining a duration of time when the article was open. If the duration of time is too short as compared to length of time users typically use to view article, then the determination can be that the content item was not effective. On the other hand, if the duration of time is above the average needed to read the article, the effectiveness of the article can be positive or neutral. Still further, if the article was identified in connection with an issue which the user was researching, and the user stopped searching or looking for additional content items, then the inference may be that the content item was effective. Likewise, if the user continues to search or navigate for additional articles, then the inference may be made that the content item was not effective.

With respect to examples described, content items 111 can also be pre-associated with activities that are deemed indicative of a positive, negative or neutral outcome. For example, the indicated activities can be associated with the categorical designation of the content item. Alternatively, the indicated activities can be selected or specified by the author of the content item. For example, if the content item provides the user with a multi-step process to resolve an issue using the service application, the activity monitoring component 136 can monitor the service application on the user device to determine whether the user initiates performance of any of the steps. If the user initiates performance, the content item can be associated with a positive outcome, and a higher performance metric for effectiveness.

The activity monitoring component 136 can include logic to calculate the performance metric for content items based on detected activities. In variations, the activity monitoring component 136 can record a post-consumption data set that enables backend logic to calculate the performance metric based on detected activities of the user after the content items are consumed. For example, processes in the content management layer 120, as represented by content analysis component 124, perform functions such as (i) determining a performance metric of a content item in connection with a user activity following the user's consumption of the content item, and (ii) updating the data store 112 to reflect updated and newly determined performance metrics for content items.

### Methodology

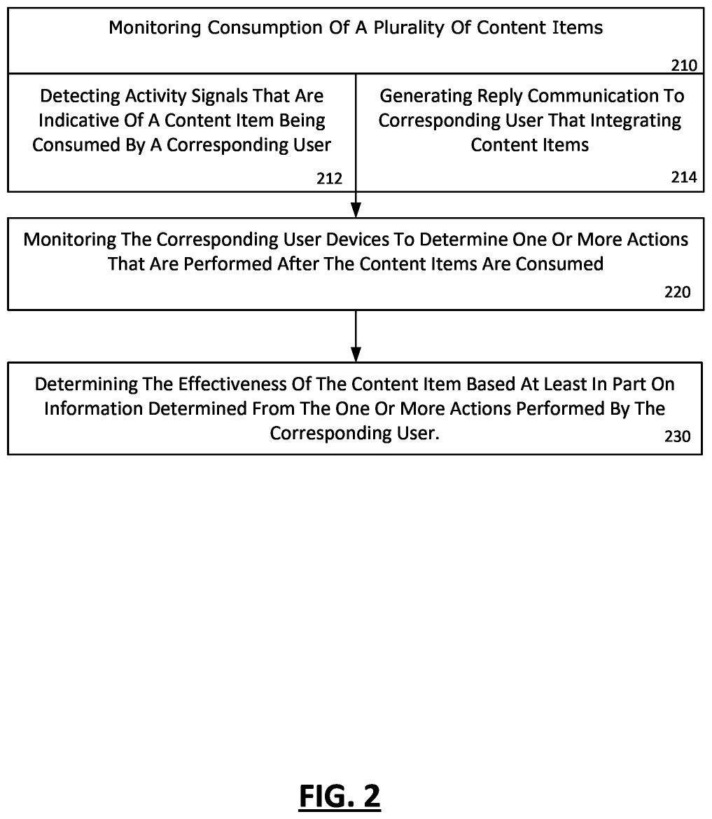

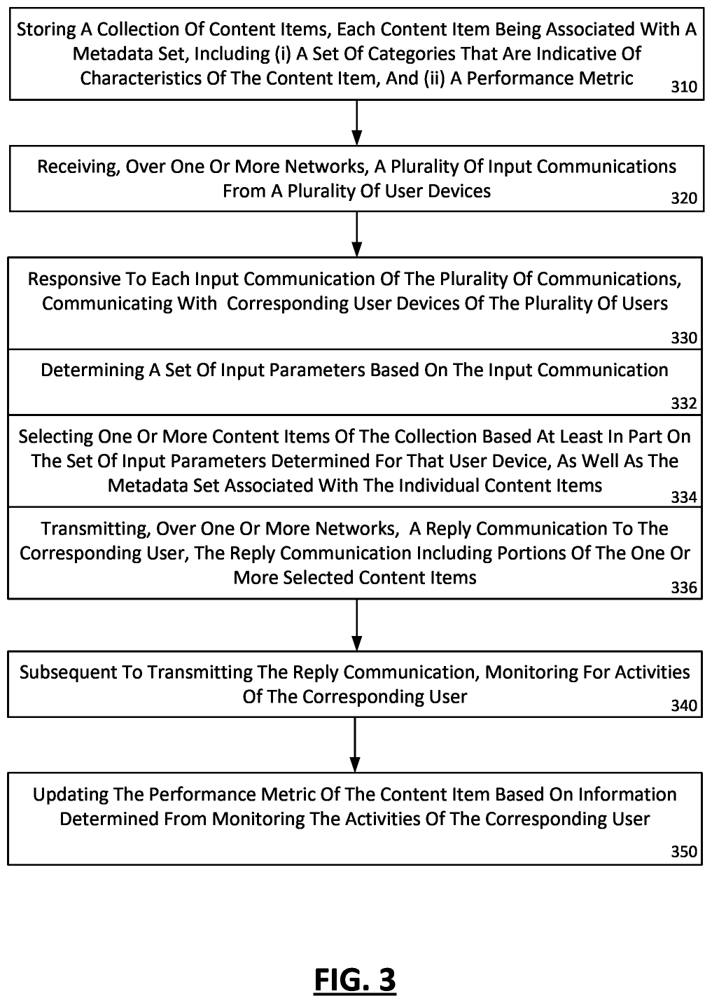

FIG. 2 illustrates an example method for a network computing system to determine effectiveness of content items of a content repository. FIG. 3 illustrates an example method for a network computing system to send reply communications that integrate content items based on effectiveness. In describing examples of FIG. 2 and FIG. 3, reference may be made to elements of FIG. 1 for purpose of illustrating suitable components and functionality for performing a step or sub-step being described.

With reference to FIG. 2, network computing system 100 monitors consumption of content items of a content repository (210). The consumption of content items can reflect users viewing, listening and/or interacting with different types of content items. The content items include support content that forms a support library for an enterprise or association. By way of example, the content items can include help articles (e.g., FAQs and knowledgebase articles), content depicting the use of UI screens, forms allow users to input details and other contextual information, saved messaging replies (e.g., in-app messages sent to users, chat responses, templates for message responses), media file tutorials, interactive voice response (IVR) content and configurations, and other types of content items.

The network computing system 100 can operate to detect consumption of content items through different types of user engagement. In examples, network computing system 100 detects activity signals that are indicative of content items being consumed by a corresponding user (212), where the activity signals are generated separate or independently of their being direct communications between the user and the network computing system 100. For example, detected activity signals can correspond to a user searching a knowledgebase to view help articles or tutorials.

As an addition or variation, network computing system 100 can integrate content items of the content repository in communications that are exchanged with the user (214). For example, the network computing system 100 can generate reply communications to users, where the reply communications are responsive to inquiries received from the users. The network computing system 100 can automatically generate and send each reply communication by integrating content item(s) that are deemed to be the most relevant and effective for the user inquiry. By way of example, content items of reply communications can selectively include empathetic content, based on historical data or other information that indicates the empathetic content is likely to improve the effectiveness of the content item.

The network computer system 100 monitors user devices to determine one or more actions that the users perform after consuming corresponding content items (220). The type of actions that are monitored can be pre-determined. Further, the types of actions can be specific to the communication channel or content type that is being consumed. Still further, individual content items can be associated with specific actions that users may take, such as in the case where the content item informs the user of a particular action that the user can take to resolve an issue.

The network computer system 100 can determine the effectiveness of the content item based at least in part on information determined from one or more actions performed by a corresponding user (230). In examples, the network computing system 100 may attribute a score or value to specific actions that individual users may perform subsequent to consuming a corresponding action item, where the score or value provides a basis for determining the effectiveness of the corresponding content item. In some examples, actions that indicate continued user engagement with a service or product (e.g., service application) or communication channel can reflect positively on the effectiveness of the content item. Similarly, in some examples, actions that indicate a disruption or discontinuance in the user's engagement with a service, product or communication channel can reflect negatively on the effectiveness of the content item that the user consumed. Still further, the content item can identify or otherwise be associated with one or more actions, for which the performance or nonperformance of indicates positively or negatively on the effectiveness of the communication, as the case may be. For example, the content item can indicate an action the user can take to address an issue that is the subject of the user's input communication. The network computing system 100 can monitor for user activity once the reply communication is received, or the content item is otherwise determined to have been consumed.

With reference to an example of FIG. 3, the network computing system 100 implements a content management platform where collection of content items are stored in the data store 112 (310). The network computing system 100 associates a metadata set with each content item, where the metadata set includes a set of categories that are indicative of a set of characteristics of the content item, as well as a performance metric that reflects the determined effectiveness of the content item. In this way, the metadata set enables the content item to be matched to input parameters determined from user input communications based on criteria of relevancy and effectiveness. Further, in examples, the performance metric can indicate a likelihood that a user will have a desired response to consuming the content item.

The network computing system 100 receives, over one or more networks, input communications from a plurality of user devices (320). The user devices can communicate with the network computing system 100 using any one of multiple possible communication channels, such as represented by service application channel 148, chat channel 146, agent channel 144 and messaging channel 142.

The network computing system 100 communicates responsively to input communications received from the user devices (330). Further, the network computing system 100 communicates responsively to input communications received over any of the available channels. Examples provide that for each input communication, the network computing system 100 determines a set of input parameters (332). For individual user devices, the network computer system 100 selects one or more content items of the collection, based at least in part on the set of input parameters determined for that user device, as well as the metadata set associated with the individual content items (334). In examples, the input parameters are matched to content items based on the set of categories that are associated with each content item. Additionally, the input parameters can be matched to content items based on the associated performance metric associated with each content item. In this way, content items are matched to input parameters of user's input communications based on criteria that includes relevancy and effectiveness.

The network computing system 100 transmits, over one or more networks, a reply communication to the corresponding user device of each incoming communication, where the reply communication includes portions of or otherwise integrates portions of the one or more matched content items (336). The network computing system 100 can generate and transmit the reply communications automatically and responsively to corresponding input communications from users. In examples, the network computing system 100 detects the incoming communications across one or more channels, processes the incoming communication for input parameters, selects one or more content items of the collection (e.g., such as by performing matching of the input parameters to content items), and subsequently composes and/or transmits a responsive reply communication that includes at least portions of, or otherwise integrates, the selected content items.

Subsequent to transmitting the reply communications to individual user devices, the network computing system 100 monitors for user activity reflecting predetermined user actions that are indicative of the effectiveness of the communication to a corresponding user (340). Based on information determined about the detected actions, the network computing system 100 updates the performance metric of the content items which are consumed on the individual user devices (350).

Among other benefits, examples as shown operate to evaluate the effectiveness of content items over time, to make content items consumed by users more effective. Examples recognize that when content items are more effective, the demand on the content management platform is reduced, while user engagement and sentiment is improved.

### Hardware Description

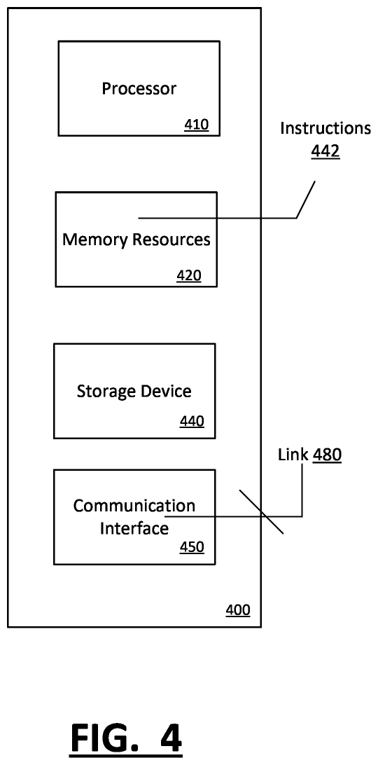

FIG. 4 illustrates a computer system on which one or more embodiments can be implemented. A computer system 400 can be implemented on, for example, a server or combination of servers. For example, the computer system 400 may be implemented as part of the of an example of FIG. 1. Likewise, the computer system 400 can implement a method such as described with an example of FIG. 2 and/or an example of FIG. 3.

In one implementation, the computer system 400 includes processing resources 410, memory resources 420 (e.g., read-only memory (ROM) or random-access memory (RAM)), a storage device 430, and a communication interface 450. The computer system 400 includes at least one processor 410 for processing information stored in the main memory 420, such as provided by a random-access memory (RAM) or other dynamic storage device, for storing information and instructions which are executable by the processor 410. The main memory 420 also may be used for storing temporary variables or other intermediate information during execution of instructions to be executed by the processor 410. The computer system 400 may also include the memory resources 420 or other static storage device for storing static information and instructions for the processor 410. The storage device 430, such as a magnetic disk or optical disk, is provided for storing information and instructions.

The communication interface 450 enables the computer system 400 to communicate with one or more networks (e.g., cellular network) through use of the network link 480 (wireless or a wire). Using the network link 480, the computer system 400 can communicate with one or more computing devices, specialized devices and modules, and one or more servers. The executable instructions stored in the memory 420 can include instructions 442, to implement a network computing system such as described with an example of FIG. 1. The executable instructions stored in the memory 420 may also implement a method, such as described an example of FIG. 2 and/or an example of FIG. 3.

As such, examples described herein are related to the use of the computer system 400 for implementing the techniques described herein. According to an aspect, techniques are performed by the computer system 400 in response to the processor 410 executing one or more sequences of one or more instructions contained in the memory 420. Such instructions may be read into the memory 420 from another machine-readable medium, such as the storage device 430. Execution of the sequences of instructions contained in the memory 420 causes the processor 410 to perform the process steps described herein. In alternative implementations, hard-wired circuitry may be used in place of or in combination with software instructions to implement examples described herein. Thus, the examples described are not limited to any specific combination of hardware circuitry and software.

### Conclusion

Although examples are described in detail herein with reference to the accompanying drawings, it is to be understood that the concepts are not limited to those precise examples. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude having rights to such combinations.

What is claimed is:

1. A network computer system comprising:
one or more processors;
a memory to store a set of instructions;
wherein the one or more processors execute the set of instructions to perform operations that comprise:
storing a collection of content items, each content item of the collection being associated with a metadata set that includes (i) a set of categories that are indicative of a set of characteristics of the content item, and (ii) a performance metric that is indicative of a likelihood that a user will have a desired response to consuming the content item;
receiving, over one or more networks, a plurality of input communications from a plurality of user devices, wherein for each input communication, the operations further comprise:
(i) determining a set of input parameters based on the input communication;
(ii) selecting one or more content items of the collection based at least in part on the set of input parameters, the set of categories, and the performance metric associated with the one or more content items;
(iii) transmitting, over the one or more networks, a reply communication to the corresponding user device, the reply communication including at least portions of the one or more selected content items;
(iv) subsequent to transmitting the reply communication, monitoring for activities of the corresponding user device; and
(V) updating the performance metric of the content item based on information determined from monitoring the activities of the corresponding user.

2. The network computer system of claim 1, wherein monitoring for activities of the corresponding user device includes receiving feedback from the corresponding user device that is indicative of an effectiveness of the content item, and wherein updating the performance metric is based on the feedback received from the corresponding user device.

3. The network computer system of claim 1, wherein monitoring for activities of the corresponding user device includes detecting the corresponding user device performing one or more actions that are correlative to an effectiveness of the content item, and wherein updating the performance metric is based on information determined about the one or more actions performed by the corresponding user device.

4. The network computer system of claim 3, wherein the one or more actions are indicative of an extent of the corresponding user device's engagement.

5. The network computer system of claim 3, wherein the one or more actions include an action the corresponding user device performs to utilize a product or service that is related to the input communication.

6. The network computer system of claim 3, wherein the one or more actions include the corresponding user device terminating a session after receiving the reply communication.

7. The network computer system of claim 1,
wherein the collection of content items are received across multiple channels, each channel being associated with a corresponding format; and
wherein the reply communication is transmitted using a corresponding channel of the input communication.

8. The network computer system of claim 7,
wherein the content items of the collection are stored in a neutral format; and
wherein transmitting the reply communication includes formatting the reply communication for the corresponding channel.

9. The network computer system of claim 1, wherein selecting the one or more content items of the collection includes identifying the one or more content items based at least in part on a relevancy determination.

10. The network computer system of claim 1, wherein selecting the one or more content items of the collection is based at least in part on a channel used to communicate with the corresponding user device.

11. A non-transitory computer-readable medium that stores instructions that when executed by one or more processors of a computer system, cause the computer system to perform operations that include:
storing a collection of content items, each content item of the collection being associated with a metadata set that includes (i) a set of categories that are indicative of characteristics of the content item, and (ii) a performance metric that is indicative of a likelihood that a user will have a desired response to consuming the content item;
receiving, over one or more networks, a plurality of input communications from a plurality of user devices, wherein for each input communication, the operations further comprise:
(i) determining a set of input parameters for the input communication;
(ii) selecting one or more content items of the collection, based at least in part on the set of input parameters, the set of categories and the performance metric associated with the one or more content items;
(iii) transmitting, over the one or more networks, a reply communication to the corresponding user device, the reply communication including at least portions of the one or more selected content items;
(iv) subsequent to transmitting the reply communication, monitoring for activities of the corresponding user device; and
(v) updating the performance metric of the content item based on information determined from monitoring the activities of the corresponding user.

12. The non-transitory computer-readable medium of claim 11, wherein monitoring for activities of the corresponding user device includes receiving feedback from the corresponding user device that is indicative of an effectiveness of the content item; and wherein updating the performance metric is based on the feedback received from the corresponding user device.

13. The non-transitory computer-readable medium of claim 11, wherein monitoring for activities of the corresponding user includes detecting the corresponding user performing one or more actions that are correlative to an effectiveness of the content item, and wherein updating the performance metric is based on information determined about the one or more actions performed by the corresponding user.

14. The non-transitory computer-readable medium of claim 13, wherein the one or more actions are indicative of an extent of the corresponding user's engagement.

15. The non-transitory computer-readable medium of claim 11,wherein the plurality of input communications are received across multiple channels, each channel being associated with a corresponding format; wherein the reply communication is transmitted using a corresponding channel of the input communication.

16. The non-transitory computer-readable medium of claim 15, wherein the content items of the collection are stored in a neutral format; and wherein transmitting the reply communication includes formatting the reply communication for the corresponding channel.

17. A computer-implemented method for managing content, the method being implemented by one or more processors and comprising:
monitoring consumption of a plurality of content items to determine the effectiveness of each content item, includes, for at least a first set of the plurality of content items, (i) detecting an activity signal that is indicative of the content item being consumed on a corresponding user device; and (ii) determining one or more actions that the corresponding user performs after the content item is consumed; and
for each content item of the first set, determining an effectiveness of the content item based at least in part on information determined from the one or more actions performed on the corresponding user device.

18. The method of claim 17,
wherein monitoring consumption of the plurality of content items to determine the effectiveness of each content item, includes, for at least a second set of the plurality of content items, (i) receiving multiple input communications, each input communication being sent by a corresponding user; (ii) in response to receiving each input communication, automatically generating a reply communication that is transmitted to the corresponding user device, the reply communication including at least a portion of one or more content items of the second set; and (iii) monitoring the corresponding user device to determine one or more actions that are performed on the corresponding user after the content item is consumed; and
for each content item of the second set, determining the effectiveness of the content item based at least in part on information determined from the one or more actions performed on the corresponding user device.

19. The method of claim 18, wherein determining the effectiveness of each of the plurality of content items includes determining a performance metric that is indicative of a likelihood that a user will have a desired response to the content item, the effectiveness being based at least in part on information determined from one or more actions performed on the corresponding user device.

20. The method of claim 19, further comprising:
storing the plurality of content items in a data store, including associating the determined performance metric with each content item of the plurality of content items.
